(19) United States
(12) Patent Application Publication
(10) Pub. No.: US 2003/0151220 A1
(43) Pub. Date: Aug. 14, 2003

(54) Handle position indication device

(76) Inventor: Jen-En Hou, Chia-I Hsien (TW)

Correspondence Address: BIRCH STEWART KOLASCH & BIRCH, PO BOX 747, FALLS CHURCH, VA, 22040-0747, US

(21) Appl. No.: 10/073,416

(22) Filed: Feb. 13, 2002

(51) Int. Cl. B62B 9/20

(52) U.S. Cl. 280/47.371

(57) ABSTRACT

A handle position indication device used in a safety seat equipped with a rotating handle, comprising embedding grooves on the safety seat and a positioning mechanism that is composed of a fastener, a spring component and a release button. When the handle is swung relative to the safety seat to a specific position, the fastener is pushed by the spring component to such a degree that it is trapped in a locked position in an embedded groove and thus fixed, though the handle may be allowed to swing freely if the fastener is pulled through a release button to a released position outside a separate embedded groove. In addition, two indicating areas (for example, a color block) are on the positioning mechanism for differentiation, while the handle has a indication window 22 through which different indicating areas are shown when the fastener is in a locked position or in a released position, so that a user may visually determine whether the handle is in a locked position or not.

### FIELD OF THE INVENTION

The present invention relates to a handle position indication device used in a safety seat designed for young children, and more particularly, a safety seat which is axially connected with a handle that can be swung and thus positioned in a used position so that the safety seat may be lifted with the handle, as well as in a folded position so that the handle is close to the sides of the safety seat.

### BACKGROUND OF THE INVENTION

Traffic accidents are one of the main types of accidents in which young children are involved, and it has been proven that safety seats can diminish the injuries young children suffer in traffic accidents. According to the law, young children riding in cars must be in safety seats in order to ensure their safety.

Suitable models of safety seats should be chosen according to young children's age and type of build. For example, infants under one year old (less than 10 kg or so) should use bed-like safety seats, so that they may be well protected while sitting in suitable, special seats. As regards this type of safety seat, it always has a handle so that it can be carried outdoors in a convenient manner, just like a basket. When the safety seat is not used, its handle rests on its edge, so that the handle is not an obstacle when taking it out, putting it away or looking after the young children.

In general, a handle is axially connected to the middle position of a safety seat, so as to allow parents to carry the safety seat outdoors by holding its handle, which is turned upwards. When the safety seat is not used, the handle rests on the edges of the safety seat, so as not to become an obstacle to taking it out, putting it away or looking after the young children.

Many of the rotating handles of safety seats nowadays are just axially connected to the safety seat, providing only the function of direction change. Hence, whenever the safety seat is used like a basket, the rotating relationship between the handle and the safety seat inevitably causes the safety seat to sway while it is being carried. There must be an angle at which the handle is held so that the gravity of the safety seat moves smoothly and steadily. However, when there is no indicator, it is not uncommon that a safety seat is lifted up when its handle has not yet reached that angle. As a result, the safety seat sways violently the moment it is lifted up, so as to keep its balance.

For this reason, some products provide a handle positioning function that allows the handle to lock the safety seat the moment the handle moves to some default position, to make sure that the safety seat is only lifted up after the handle is moved to a fixed position so the safety seat will not swing relative to the handle, and the safety seat will be safer. However, as regards the existing, known products, their designs of positioning structure of the handle are rather complicated. Moreover, many users remain unsatisfied, despite the positioning function, because users are often unable to determine whether they have securely positioned a handle or not. As a result, users are dubious of the safety seats and thus they cannot be at ease. The underlying reason is that the existing positioning structures do not have a position status indication function at all. Users can only rely upon the sound generated with successful positioning and locking to determine whether they have positioned a handle or not. However, such kind of judgment method is not good enough, because it is impossible for users to hear any sound generated on successful positioning and locking when the surroundings are noisy.

### SUMMARY OF THE INVENTION

In view of this, the primary object of the invention is to create a handle position indication device that streamlines the constituent components and, more importantly, allows users to determine definitely whether they have positioned a handle or not.

According to the foregoing object, the invention is primarily designed to allow users to use their eyes to see whether a handle is positioned or not, so that the position status of a handle may be determined directly by means of vision. The handle position indication device disclosed in the invention comprises embedding grooves found on the safety seat, and a positioning mechanism that is found on the handle and is composed of elements such as a fastener, a spring component and a release button. By means of the aforesaid constitution, not only can the handle have the basic function of positioning, but also the invention provides two indicating areas on the fastener or the release button for differentiation, which, coupled with the indication window 22 found on the handle, allow users to determine the positioning status of the handle by making reference to the indicating areas seen through the indication window 22.

The detailed characteristics of the invention are illustrated in detail with preferred embodiments and related drawings as found below.

### BRIEF DESCRIPTION OF THE DRAWINGS

FIG. 1 shows the disassembled parts of the safety seat equipped with the handle devised in the invention;

FIG. 2 is a cross-sectional diagram of the invention when viewed from outside the handle;

FIG. 3 is a cross-sectional diagram of the invention when viewed from the interior of the handle;

FIGS. 4A & 4B are diagrams showing the fastener of the invention in a locked position and in a released position, respectively;

FIG. 5 is a plan of the forces and the brakes of the invention, showing how the handle swings axially relative to the safety seat;

FIG. 6 is a motion diagram of the invention, showing how the handle swings axially relative to the safety seat and stops in another position;

FIG. 7 is a diagram of another embodiment of the invention, showing how the indicating area is installed in the release button;

FIG. 8 is a motion diagram of another embodiment of the invention.

### DETAILED DESCRIPTION OF THE PREFERRED EMBODIMENTS

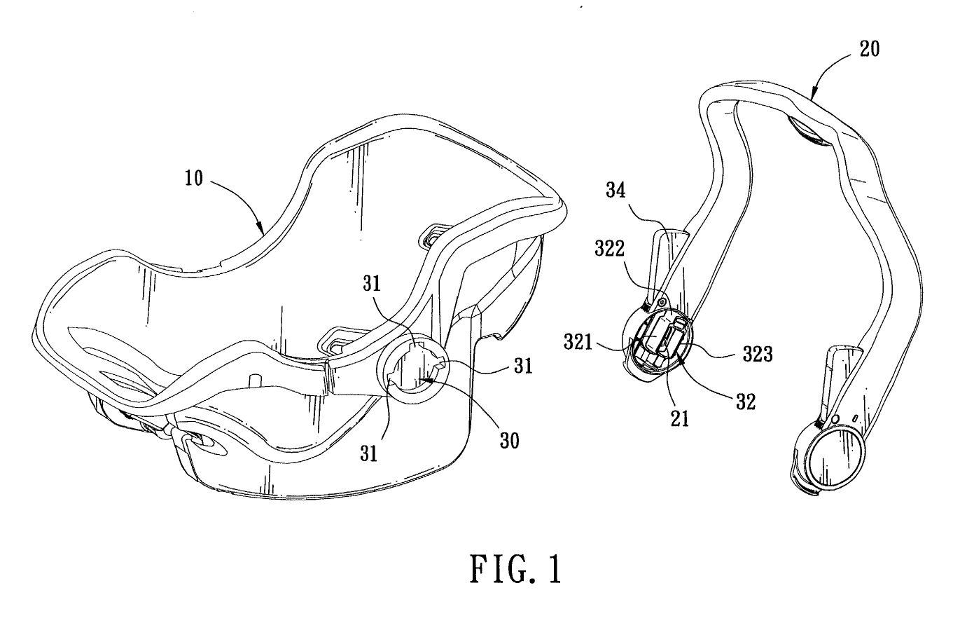

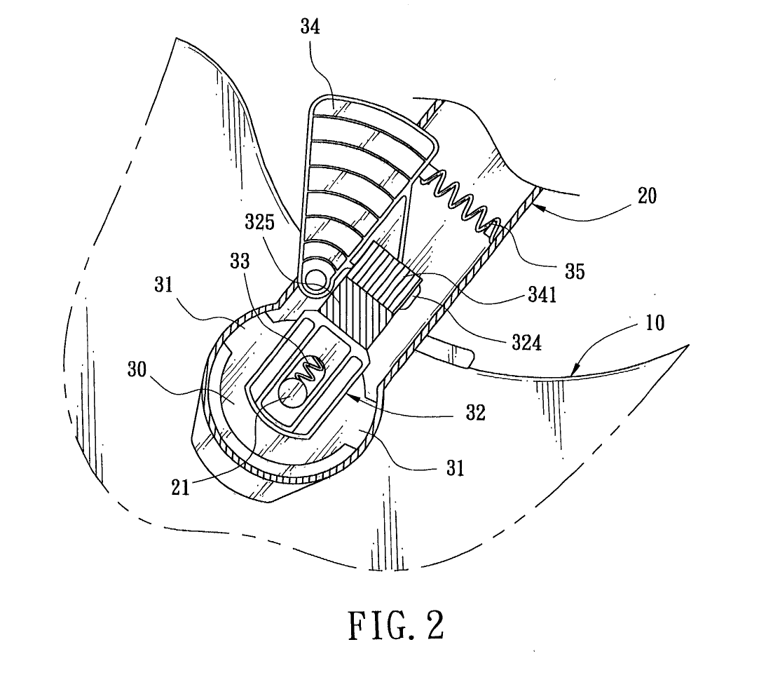

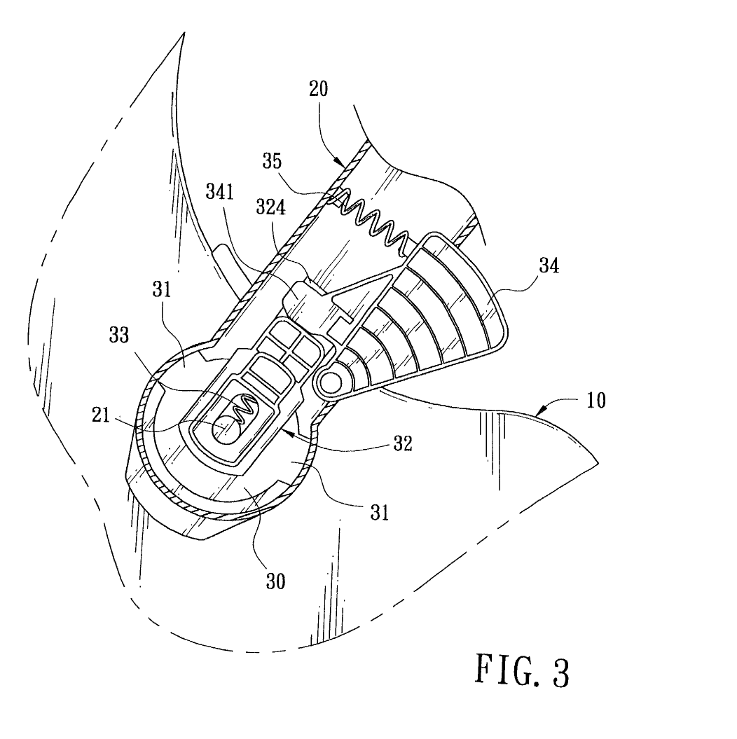

As shown in FIGS. 1, the invention relates to a handle position indication device used in a safety seat 10 designed for young children. It is used in a position in which the safety seat 10 is axially connected with a handle 20, so that when the handle 20 swings and ends up in a used position for lifting up the safety seat 10, as well as in a folded position in which the handle 20 is close to the sides of the safety seat 10, the handle 20 may be provided with safe positioning and an indicating function. As shown in the diagram of the preferred embodiment, the handle position indication device comprises more than one embedding groove 31 found on the safety seat 10, and a positioning mechanism that is composed of elements such as a fastener 32, a spring component 33 and a release button 34, all found inside the handle 20. Detailed description, including FIGS. 2 and 3, of the components of the invention is as follows:

Firstly, the embedded grooves 31 are integrated with the external margin of the circumference of a holding groove 30 found on the safety seat 10, and are connected with a holding groove 30.

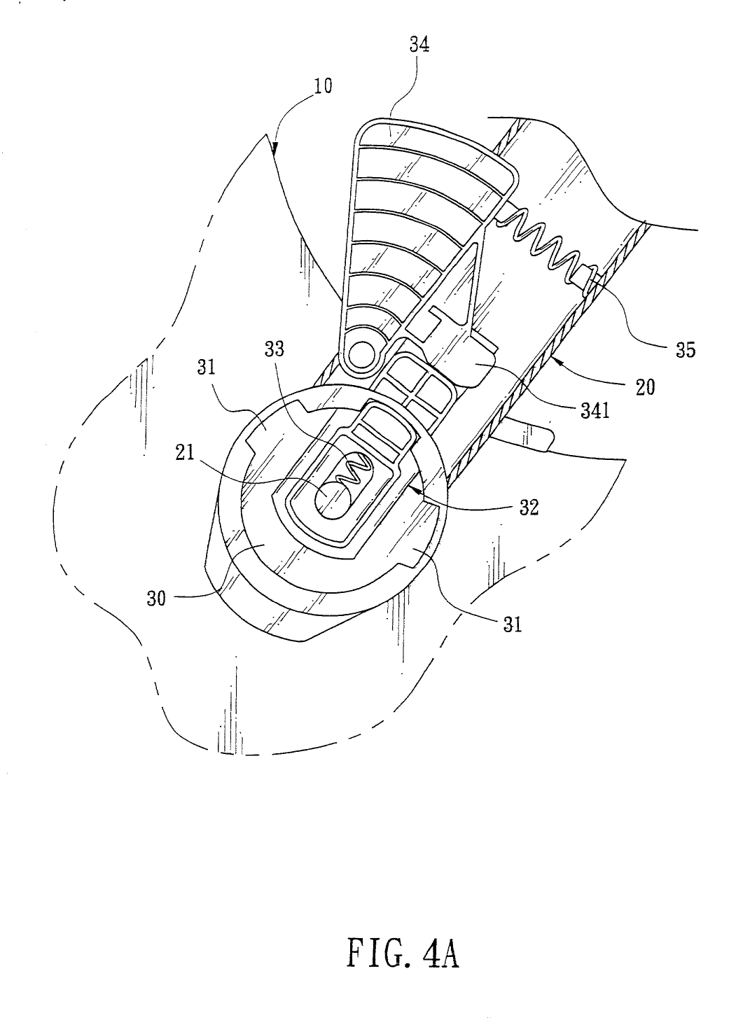

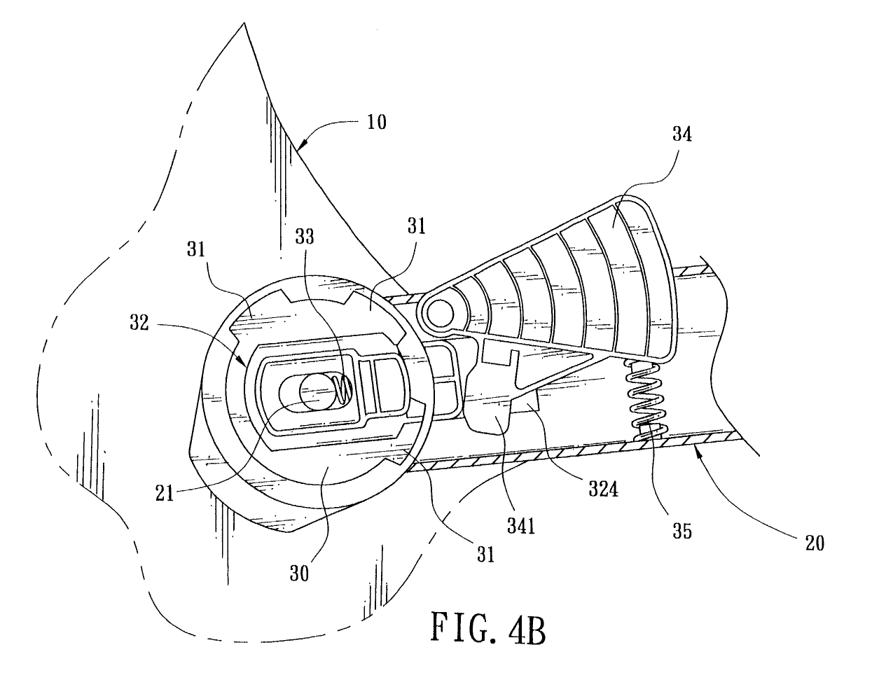

The fastener 32 is integrated into, and slides relative to, the handle 20, and its extension gives rise to a brake 321 and an extender 322 that reaches the inside of the handle 20. On the brake 321 is a slot 323 that embraces a pivotal shaft 21 of the handle 20 and slides along the pivotal shaft 21. After the handle 20 has been axially connected to the safety seat 10, the brake 321 may enter the holding groove 30. When the handle 20 swings and ends up in the aforesaid used position or folded position, the fastener 32 may slide in a controlled direction and end up in a locked position so that the brake 321 will be locked in the embedding groove 31 (as shown in FIG. 4A), forming a lock that restricts the axial swing of the handle 20 relative to the safety seat 10, or allowing the handle 20 to swing relative to the safety seat 10 and end up in a released position (as shown in FIG. 4B) so that the handle 20 may swing freely relative to the safety seat 10.

The spring component 33 is placed in the slot 323 of the fastener 32, with one end resting on the pivotal shaft 21 of the handle 20, and the other end resting on an end of the slot 323. Its function is to exert an elastic force upon the fastener 32 so as to keep the fastener 32 in a normal status of outbound movement. As a result, whenever the handle 20 is in the used position or in the folded position, the fastener will be pushed and moved to the locked position.

The release button 34 is axially located at the handle 20, and it locks the extender 322 of the fastener 32 by means of an axial swing to drive the fastener 32 back to the released position, so as to allow the handle 20 to swing relative to the safety seat 10. The release button 34 may be equipped with a push part 341 that is used to push the extender 322, and, through the extender 322, make the release button 34 stick out from the handle 20 in an outward manner so that the release button 34 may be exposed to the press part 342 found outside the handle 20. In addition, as shown in the diagrams of the present embodiment, the release button 34 may be connected to a pop-up spring 35 that forces the press part 342 to expose itself outside the handle 20 in a normal state.

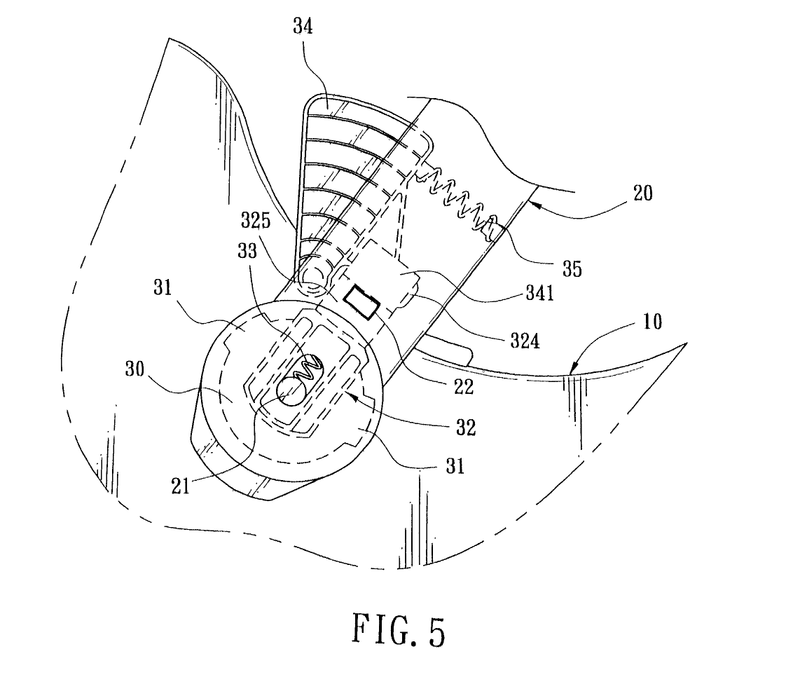

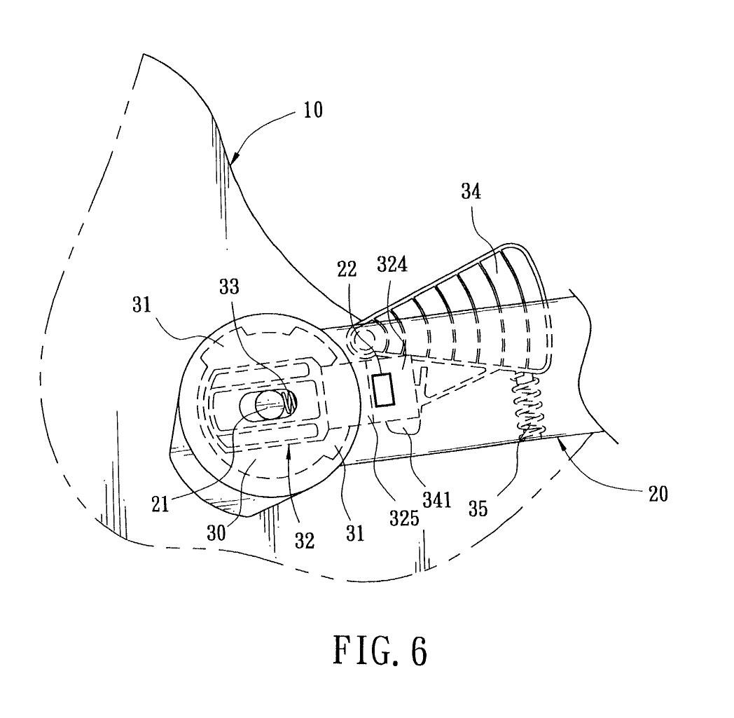

To sum up, when the handle 20 swings and ends up in the used position or the folded position, the fastener 32 may be pushed by the spring component 33 to such a degree that the fastener 32 shifts from the released position to the locked position, so as to stop the handle 20 from swinging relative to the safety seat 10. Unless the fastener 32 returns to the released position through a brake exerted by the release button 34, the handle 20 will not be able to swing relative to the safety seat 10 and end up in another position (as shown in FIGS. 5 & 6).

In addition, to allow users to determine definitely whether a handle 20 is positioned or not, the invention specifies two different indicating areas 324 and 325 visually identifiable on the extender 322 of the fastener 32. For example, on the extender 322 two separately specified areas are painted and given different colored blocks. An indication window 22 is installed on the handle 20, so that when the fastener 32 is in the locked position or in the released position, users may look to determine whether the handle 20 is positioned or not by making reference to the different indicating areas 324 and 325 shown in the indication window 22.

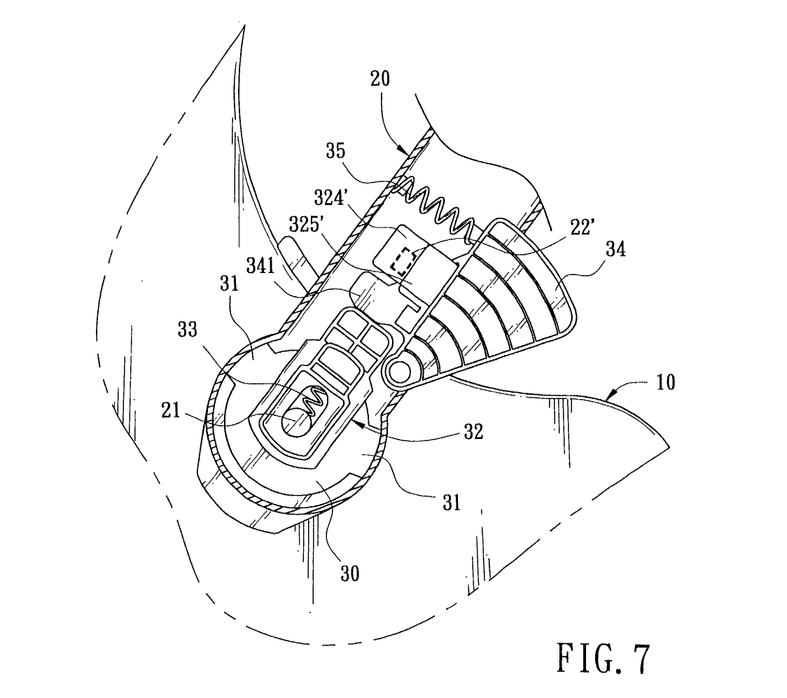

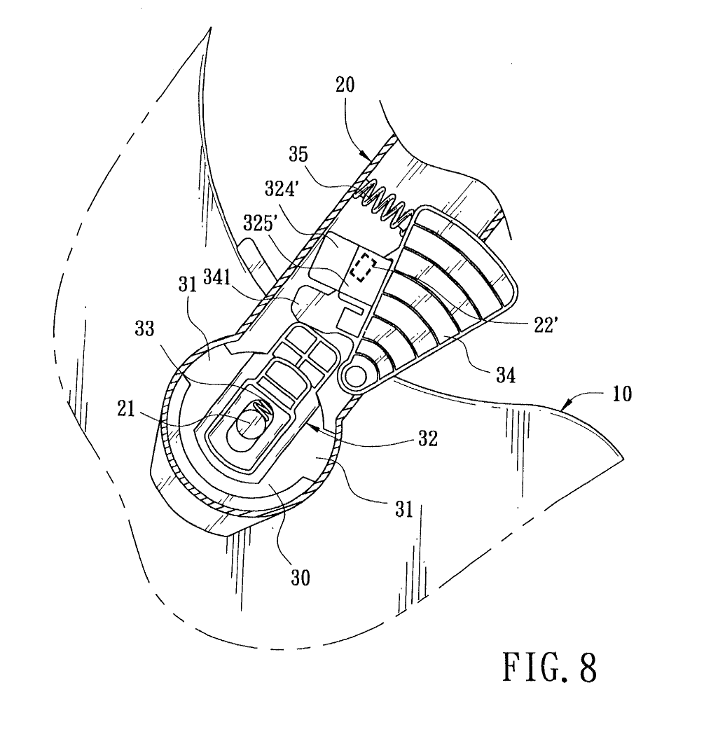

Please see FIGS. 7 & 8, which show another embodiment of the indicating areas 324′ and 325′ of the invention. Given the joint motion relationship between the release button 34 and the fastener 32, provided that the release button 34 and the fastener 32 move as a single body, the indicating areas 324′ and 325′ may be installed on the release button 34, and the indication window 22′ originally installed on the handle 20 may also be moved to another area, so that when the release button 34 sets the fastener 32 in the release position or in the locked position, users may see the different indicating areas 324′ and 325′ through the indication window 22′.

### Effect of the Invention

The invention discloses a handle position indication device that is not only simplified and streamlined, but also allows a user to visually determine definitely whether a handle is positioned or not, with a view to avoiding the problems that may arise from lifting a safety seat before positioning its handle.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A handle position indication device used in a safety seat equipped with a rotating handle that can be moved to a used position so that the safety seat may be lifted with the handle, as well as to a folded position so that the handle is close to the safety seat; it comprises:
more than one embedding grooves, found on a part of the safety seat that connects the safety seat with the handle;
a positioning mechanism, which is composed of a movable fastener found on the handle, a spring component that rests on the fastener, and a release button that pulls the fastener, so that when the handle is in the used position or in the folded position, the fastener will normally be pushed and moved by the spring component to, and be locked in, a locked position in the embedding groove, leading to the consequence that the handle and the safety seat are fixed to each other, or the release button may be braked and driven to a released position so that the handle may swing relative to the safety seat;
indicating areas, installed on the positioning mechanism; and
a indication window, installed on the handle, with a purpose that when the fastener is in the locked position or in the released position, the indication window may show different indicating areas.

2. The handle position indication device as claimed in claim 1, wherein the handle is equipped with a holding groove to hold the fastener.

3. The handle position indication device as claimed in claim 1, wherein the fastener is equipped with a slot which embraces a pivotal shaft of the handle, so that the fastener may slide relative to the handle.

4. The handle position indication device as claimed in claim 1, wherein the indicating areas are found on the fastener.

5. The handle position indication device as claimed in claim 4, wherein the fastener is also equipped with an extender on which the indicating areas are installed.

6. The handle position indication device as claimed in claim 5, wherein the release button is equipped with a push part that may brake the extender.

7. The handle position indication device as claimed in claim 1, wherein the indicating areas are colored blocks.

8. The handle position indication device as claimed in claim 1, wherein the release button is connected with a pop-up spring that forces the release button to expose outside the handle at least part of its portion responsible for braking.

9. The handle position indication device as claimed in claim 1, wherein the indicating areas are installed on the release button.
